(19) United States
(12) Patent Application Publication
(10) Pub. No.: US 2016/0147772 A1
(43) Pub. Date: May 26, 2016

(54) TOPOLOGY-DRIVEN DATA ANALYTICS FOR LOCAL SYSTEMS OF A SYSTEM LANDSCAPE

(71) Applicants: Steffen SIEGMUND, St. Leon-Rot (DE); Ralf STAUFFER, Schwegenheim (DE); Arndt EFFERN, Sinsheim (DE); Guenter BRIAM, Wiesloch (DE)

(72) Inventors: Steffen SIEGMUND, St. Leon-Rot (DE); Ralf STAUFFER, Schwegenheim (DE); Arndt EFFERN, Sinsheim (DE); Guenter BRIAM, Wiesloch (DE)

(21) Appl. No.: 14/550,204

(22) Filed: Nov. 21, 2014

(51) Int. Cl. G06F 17/30

(52) U.S. Cl. CPC G06F 17/3056; G06F 17/30595; G06F 17/30389; G06F 17/30554; G06F 17/30345

(57) ABSTRACT

A user interface (UI) manager may receive, at an analyzer agent executing within a system of a system landscape, a request for data analysis of component data of an infrastructure component of the system. A request controller may collect, in response to the request, topology data for the system, the topology data including a characterization of the infrastructure component. A content manager may filter, using the topology data, system-specific metadata, to obtain filtered system-specific metadata, and a a request processor may generate, based on the request and the filtered system-specific metadata, a query against the component data.

### TECHNICAL FIELD

This description relates to data analytics.

### BACKGROUND

System landscapes may refer generally to one or more systems deployed by one or more entities, often for the purpose of pursuing a particular objective (e.g., such as when a business entity deploys a plurality of such systems for the purpose of maximizing profits and customer satisfaction). Within such system landscapes, deployed systems may be large in size or in number, and may be heterogeneous, geographically dispersed, subject to change over time, and may contain large quantities of data. Moreover, such systems are often required to be highly available, with minimal numbers of malfunction or other service disruptions.

In order to fully utilize such deployed systems, and to minimize malfunctions or other service disruptions thereof, it is helpful to have an ability to analyze data that is included in, characterizes, or is otherwise associated with various components of the various systems of a system landscape. In order to provide such data analytics, centralized data collection and analysis techniques have been developed, in which data from the various systems of a system landscape may be replicated and stored at a centralized network location. In this way, analytic requests may be issued against the replicated, centralized data, to thereby provide system administrators and other users with useful information regarding a description, interpretation, modification, health, status, or other aspect of specified portions of the system landscape.

However, in many scenarios, such data replication for centralized data analytics is costly, time-consuming, and often incapable of providing real-time, or near real-time, analysis results. Consequently, it may be difficult or impractical for an administrator of a system landscape to obtain analysis results in a desired, cost-effective, and timely manner.

### SUMMARY

According to one general aspect, a computer program product may be tangibly embodied on a non-transitory computer-readable storage medium and may include instructions that, when executed, are configured to receive, at an analyzer agent executing within a system of a system landscape, a request for data analysis of component data of an infrastructure component of the system, and collect, in response to the request, topology data for the system, the topology data including a characterization of the infrastructure component. The instructions, when executed, may be further configured to filter, using the topology data, system-specific metadata, to obtain filtered system-specific metadata, and generate, based on the request and the filtered system-specific metadata, a query against the component data.

According to another general aspect, a computer-implemented method for executing instructions stored on a non-transitory computer readable storage medium may include receiving, at an analyzer agent executing within a system of a system landscape, a request for data analysis of component data of an infrastructure component of the system, and collecting, in response to the request, topology data for the system, the topology data including a characterization of the infrastructure component. The method may further include filtering, using the topology data, system-specific metadata, to obtain filtered system-specific metadata, wherein the system-specific metadata includes data models modeling system data of the system, and the filtered system-specific metadata includes a subset of the data models relevant to the infrastructure component, mapping the subset of the data models to a corresponding interface of the infrastructure component, and generating, based on the request and the mapping, a query against the component data.

According to another general aspect, a system may include instructions recorded on a non-transitory computer-readable storage medium, and executable by at least one processor. The system may include a user interface (UI) manager configured to cause the at least one processor to receive, at an analyzer agent executing within a system of a system landscape, a request for data analysis of component data of an infrastructure component of the system, and a request controller configured to cause the at least one processor to collect, in response to the request, topology data for the system, the topology data including a characterization of the infrastructure component. The system may include a content manager configured to cause the at least one processor to filter, using the topology data, system-specific metadata, to obtain filtered system-specific metadata; and a request processor configured to cause the at least one processor to generate, based on the request and the filtered system-specific metadata, a query against the component data.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system landscape providing topology-driven data analytics for local systems thereof

FIG. 2 is a flowchart illustrating example operations within the system landscape of FIG. 1.

FIG. 3 is a block diagram of an architecture of an analyzer agent of the system of FIG. 1.

FIG. 4 is a block diagram of a request controller of the architecture of FIG. 3.

FIG. 5 is a block diagram illustrating operational software layers implemented in the example of FIG. 3.

FIG. 6 is a block diagram illustrating an example design time and an example runtime for implementations of the system landscape of FIG. 1.

FIG. 7 is a flowchart illustrating more detailed example operations of the examples of FIGS. 1-6.

### DETAILED DESCRIPTION

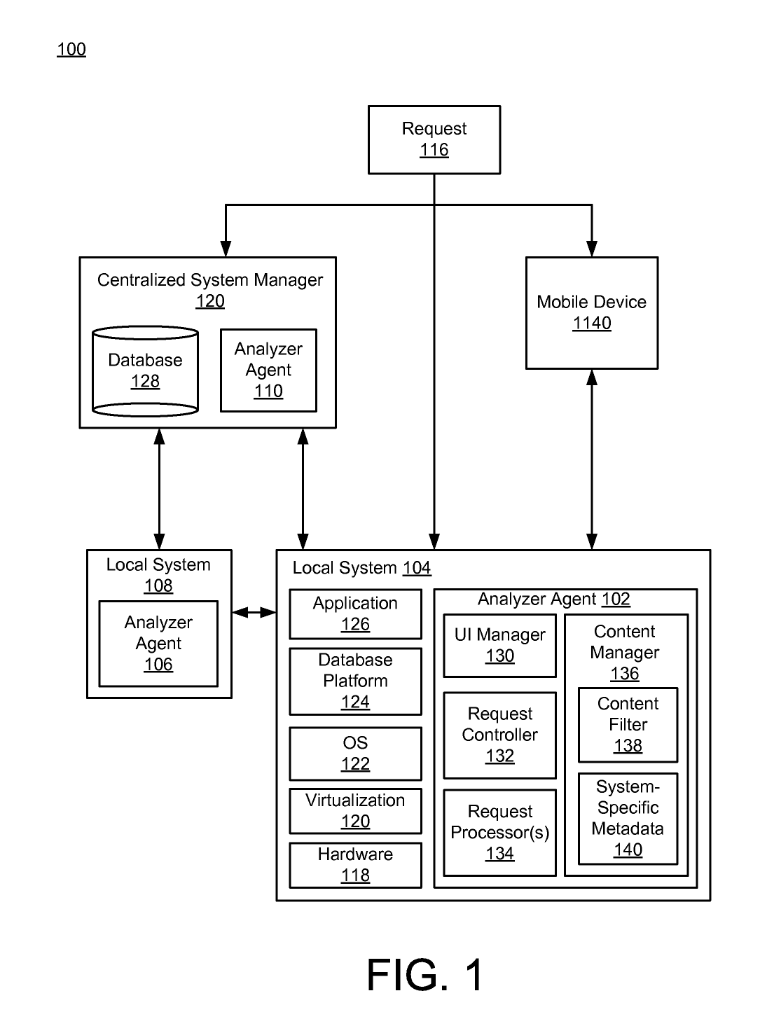

FIG. 1 is a block diagram of a system landscape 100 for topology-driven data analytics for local systems of the system landscape 100. As described in detail below, the system landscape 100 operates in a manner that relies on local, decentralized data collection, while utilizing collected data and without requiring replication to a central location. Moreover, within the system landscape 100, data analysis may be performed locally to a location of the data being analyzed. Further, data analysis may be performed in a variety of contexts, and in a manner that is highly specific to particular deployed systems. As a result of these and other features and functions of the system landscape 100, system administrators and other users may be provided with the information necessary to maintain ongoing operations within the system landscape 100, while also optimizing the use of data stored throughout the system landscape 100.

In more detail, as shown in FIG. 1, an analyzer agent 102 may be deployed at a local system 104 of the system landscape 100. Similarly, an analyzer agent 106 is illustrated as being deployed at a second local system 108 of the system landscape 100. Meanwhile, an analyzer agent 110 is illustrated as being deployed locally to a centralized system manager 112.

Thus, in the example of FIG. 1, it is assumed, for the sake of explanation and example, that the system landscape 100 includes a plurality of local systems, represented in the simplified example of FIG. 1 by the two local systems 104, 108. In a business context, as referenced above, each such system may represent or include, for example, specific software-based business solutions. For example, such a system may include an enterprise resource planning (ERP) system, a customer relationship management (CRM) system, a supply chain management (SCM) system, or virtually any other business-related systems designed to facilitate operations of the business in question. Thus, such systems should be understood to represent virtually any system designed to improve internal business procedures (e.g., employee management, human resources, financial planning, or regulatory concerns), interactions with customers (e.g., customer transactions, or customer support), or interactions with external suppliers or other vendors (e.g., arranging and monitoring deliveries or other interactions or managing contractual obligations with vendors).

Of course, the above examples are provided merely as non-limiting possibilities for implementation of the system landscape 100. Many other examples in various business contexts would be apparent. Moreover, the system landscape 100 may be implemented in non-business related scenarios, such as in governmental, educational, or non-profit scenarios, in which case the various local systems 104, 108 would be understood to be implemented in a manner suitable for the corresponding context.

As also referenced above, in many implementations, the system landscape 100 will include large quantities of potentially dispersed data. Moreover, a manner in which such data is stored within and among the various local systems 104, 108 may vary, perhaps widely, e.g., in the type, format, or structure of the stored data. Still further, all such aspects of the data, the data itself, and any hardware/software platform or component used to store or access the data may vary over time in a dynamic fashion (e.g., may be deleted, updated, or replaced).

Notwithstanding the above, it is well known that users of the system landscape 100 may desire to issue a request 116 against specific parts of the stored data. That is, the request 116 should be broadly understood to represent virtually any request for data analysis that might be issued within the context of the system landscape 100. For example, the request 116 may be related to a desired analysis of the types of data stored in the various business software systems referenced above, such as customer data, inventory data, or employee data. The request 116 also may relate to a desired analysis of a manner in which the types of data just referenced are stored within the system landscape. For example, the request 116 may request information regarding a table size or other data storage/access characteristics of specified data. Such information may thus be understood to represent metadata characterizing a manner in which data is stored, where such metadata may be stored explicitly in a corresponding repository, or may be obtained through analysis of the data in question.

In yet further examples, the request 116 may relate to an operational status of software or hardware executing within the system landscape 100. Thus, such requests may not relate directly to the types of data referenced above (e.g., business data), but may instead include data characterizing historical or current operational conditions, including outages, disruptions, or other malfunctions or potential malfunctions of system components.

With respect to all, or virtually all, of the types of data that may be analyzed as a result of the request 116, including the various examples just mentioned, it will be appreciated that the various types of data may be provided by different entities or other providers, even within a single local system. For example, a business deploying the system landscape 100 may utilize multiple software vendors, multiple information technology (IT) support vendors, and/or may deploy custom-built or other proprietary systems within the system landscape 100. Thus, the request 116 will generally be required to comply with, or otherwise interact with, all such data providers, and all data stored within the system landscape 100.

In some scenarios, the centralized system manager 112 may be configured and deployed for the purpose of enabling analytic requests, such as the request 116. In order to address the types of concerns described above with respect to a scope, variety, and format of data within the system landscape 100, it is possible for the centralized system manager 112 to replicate data from across the system landscape 100, for uniform storage thereof within a database 128 of the centralized system manager 112. Such an approach has an advantage of providing a single, central location for application of analytic requests, as well as a uniform interface for receiving and responding to such requests. Further, in such scenarios, the centralized system manager 112 may bear a large portion of a computational burden of processing such requests. Thus, the centralized system manager 112 may be suitable in scenarios in which, for example, a system landscape is relatively small and/or homogenous, and/or in which the included local systems do not possess the computational resources required to execute analytic requests directly.

On the other hand, such data replication is often expensive and time-consuming. Moreover, such data replication is often required to be done asynchronously, in batch processing modes, so that the replicated data within the database 128 may be out of date to varying degrees. Further, when the centralized system manager 112 is provided by a particular vendor for the benefit of the business or other entity implementing the system landscape 100, the centralized system manager 112 may potentially only be able to replicate vendor-specific data within the database 128, thereby potentially limiting an effectiveness of this approach.

In the example of FIG. 1, however, the analyzer agents 102, 108, 110 are configured and implemented to reduce or eliminate a need for the type of centralized data replication just described. More particularly, the analyzer agents 102, 106, 110 may be configured to execute in a standardized, substantially uniform manner, while nonetheless being adaptable for operation within an individual local system or other setting within the system landscape 100.

For example, the analyzer agent 102, prior to deployment to the local system 104, may be the same as, or similar to each of the analyzer agents 106, 110, or a generic analyzer agent from which the three analyzer agents 102, 106, 110 are created. Nonetheless, as just referenced, the analyzer agent 102 may be adaptable for execution within the local system 104. In particular, as described in detail below, the analyzer agent 102 may be configured to utilize topology data related to various infrastructure components of the local system 104 (represented by example infrastructure components 118-126, as described below), in conjunction with provided knowledge regarding such infrastructure components. In this way, the analyzer agent 102 may collect or otherwise determine the types of data described above with respect to the centralized system manager 112, and may thereafter apply the request 116 against such data, in order to satisfy the request 116.

Advantageously, then, the analyzer agent 102 may be observed to reduce or eliminate a need to replicate data from the local system 104 to the centralized system manager 112, since the analyzer agent 102 enables satisfaction of the request 116, locally to the local system 104. Moreover, because the analyzer agent 102 has specific knowledge of the various infrastructure components 118-126 of the local system 104, and related information, the analyzer agent 102 may provide a uniform, integrated view of, or access to, virtually all relevant data within the local system 104, regardless of whether the data is provided by one or more vendors, or by an owner of the system landscape 100.

As a result, as referenced above and illustrated in the example of FIG. 1, the request 116 may be provided to the local system 104 using a convenient variety of techniques. For example, as shown, the request 116 may be routed through the centralized system manager 112 to the local system 104, or may be submitted by way of a mobile device 114. In many implementations, the request 116 may be provided directly to the analyzer agent 102, through the use of a user interface associated therewith. Also, because the analyzer agents 102, 108, 110 are constructed similarly to one another, communication between the various analyzer agents 102, 108, 110 may be executed in a unified, straightforward manner, even when a large number of analyzer agents are deployed within a given system, or within multiple different local systems.

In addition to this uniformity and inoperability, and as just described with respect to the analyzer agent 102, each of the analyzer agents 102, 108, 110 may easily be adapted for specialized execution within its deployed system environment. For example, although not specifically illustrated in the simplified example of FIG. 1, the analyzer agent 106 with the local system 108 may be required to perform analysis of, and issue requests against, very different types of data and associated infrastructure components than the analyzer agent 102, since, as already described, features and functions of the local system 108 may be very different from those of the local system 104.

Similarly, the analyzer agent 110 may be highly adaptable for execution within the centralized system manager 112. For example, as described in detail below, the analyzer agent 110 may serve as a proxy for one or both of the analyzer agents 102, 106. For example, in scenarios in which the request 116 is submitted to the centralized system manager 112, the analyzer agent 110 may determine that the request 116 is related to the local system 104, and may route the request 116 accordingly, using the above-referenced communication capabilities existing between the analyzer agent 110 and the analyzer agent 102. In this way, for example, a user of the centralized system manager 112 may continue to use familiar user interface functionality already deployed in association therewith, while nonetheless gaining the benefits described herein with respect to the analyzer agent 102. In some implementations, a hybrid solution may be implemented in which the centralized system manager 112 replicates data from one or more systems of the system landscape 100, while one or more analyzer agents are deployed to remaining systems of the system landscape 100. In this way, for example, benefits of both the centralized system manager 112 and the agent-based aspects of the system landscape 100 may be obtained in various implementation scenarios.

In the example of FIG. 1, as referenced above, the local system 104 is illustrated as including various infrastructure components 118-126. As shown, the local system 104 may include various types of hardware 118, which may generally represent virtually any computer hardware (e.g., processor or memory) that may be utilized to implement the local system 104. For example, the hardware 118 may include at least one processor, along with a non-transitory, computer readable storage medium that is configured to store instructions that are executable by the at least one processor of the hardware 118. Through the execution of such instructions, remaining infrastructure components 120-126 may be implemented. Further, of course, the analyzer agent 102 also may be implemented using these and other aspects of the hardware 118.

In various implementations, the hardware 118 may represent a large number of potentially dispersed, network-connected computing devices, all of which are considered to be part of the local system 104. In some cases, some of these types of dispersed hardware components may be utilized to implement portions of other local systems, e.g., the local system 108. In other words, it may occur that some or all of the hardware 118 is shared between two or more local systems of the system landscape 100. Nonetheless, it will be appreciated from the present description that the local system 104 is generally defined and described with respect to a specific stack of infrastructure components deployed in an associated topology with respect to one another and within a relevant network environment.

One technique for sharing hardware components within the local system 104, as well as across multiple local systems 104, 108, is represented by a virtualization infrastructure component 120. As is known, virtualization 120 refers generally to the use of software to create virtual computers or other computing devices that share hardware resources of the underlying hardware 118, while otherwise executing independently of one another and in the experience of users thereof.

For example, such virtual machines may each execute a different operating system (OS), so that the OS 122 of FIG. 1 should be understood to represent one or more different types of operating systems executing on one or more corresponding, underlying virtual machines provided by the virtualization 120. As also shown, within each such operating system and associated virtual machine, a database platform 124 may be installed. Then, for each such database platform 124, one or more applications, represented by an application 126, may be installed and executed.

Of course, it will be appreciated that the infrastructure components 118-126 illustrated in FIG. 1 are intended merely to represent a non-limiting example of potential stacks of infrastructure components that may be deployed within a given local system. That is, for example, additional or alternative infrastructure components may be included, while, in other implementations, one or more of the illustrated infrastructure components 118-126 (e.g., the virtualization 120) may be omitted.

Within the analyzer agent 102, a user interface (UI) manager 130 may be configured to provide various types of user interfaces on behalf of the analyzer agent 102. For example, as referenced above, the UI manager 130 may provide a graphical user interface (GUI) to receive the request 116 directly from the user of the local system 104. In other implementations, the UI manager 130 may provide one or more user interfaces for interacting with the centralized system manager 112, the mobile device 114, or virtually any other human or machine source of the request 116.

Thus, through the use of the UI manager 130, a request controller 132 may receive the request 116. In order to process the request 116 during a runtime of the analyzer agent 102, the request controller 132 may obtain topology data related to a topology of the various infrastructure components 118-126. The resulting topology data may be used as input to a content manager 136, specifically, to a content filter 138 that uses the topology data to filter system-specific metadata 140 stored by the content manager 136.

The resulting, filtered, system-specific metadata may be utilized by the request controller 132, in conjunction with the request 116, to implement one or more request processors 134 for interacting with relevant ones of the infrastructure components 118-126. More particularly, and as described in detail below, the system-specific metadata 140 may generally represent, e.g., metadata characterizing techniques for generating queries against virtually any possible infrastructure component that may be included within the local system 104, and variations thereof.

For example, within the local system 104, the hardware 118 may support two different instances of the application 126, where the two different application instances may be different versions of the same application. Then, when the request controller 132 determines such version-specific characterizations of the instances of the application 126 within the topology data, the topology data may be used to cause the content filter 138 to obtain those portions of the system-specific metadata 140 which relate to the application 126, and, specifically, which enable queries against the application instances that will be compatible with the actual versions of the application 126 that have been deployed within the local system 104.

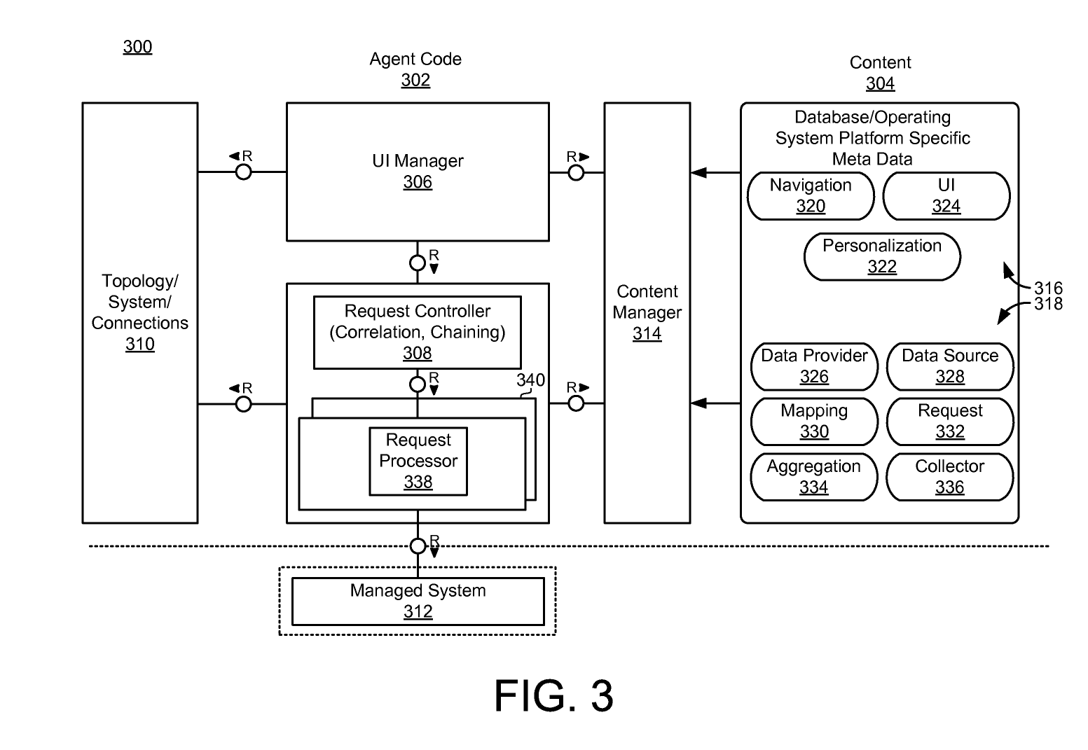

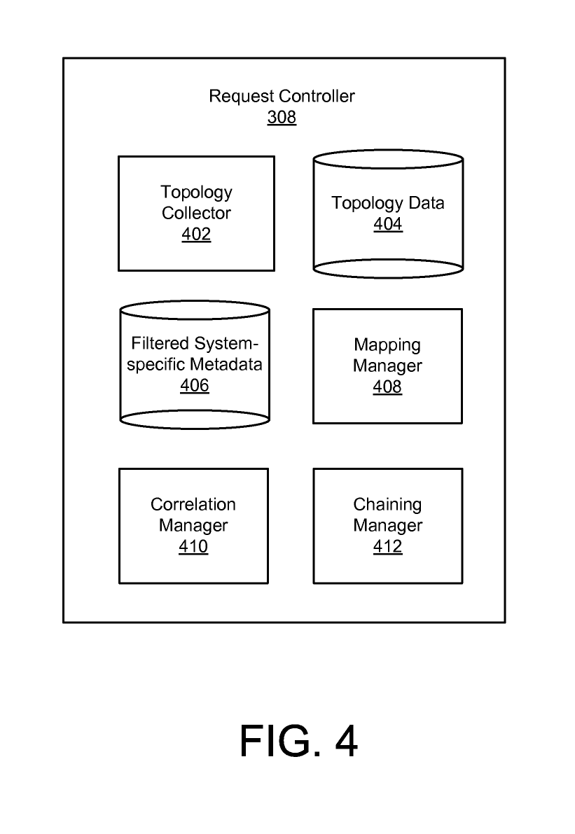

In some implementations, as described in detail below with respect to FIG. 3, a request processor may be generated for each infrastructure component that may be relevant to the request 116. For example, a request processor 134 may be generated for a portion of the request 116 related to the OS 122, while a separate request processor 134 may be generated for portions of the request 116 related to the database platform 124. Then, as also described with respect to FIG. 3, and as described in more detail with respect to FIG. 4, the request controller 132 may be configured to coordinate interactions with such a plurality of request processors 134, and may aggregate or otherwise consolidate outputs thereof for returning results of the request 116 by way of the UI manager 130. As also described in detail below with respect to FIGS. 3 and 4, the request controller 132 may also be configured to interact with, or otherwise coordinate communication between, the various other analyzer agents 106, 110 of the system landscape 100.

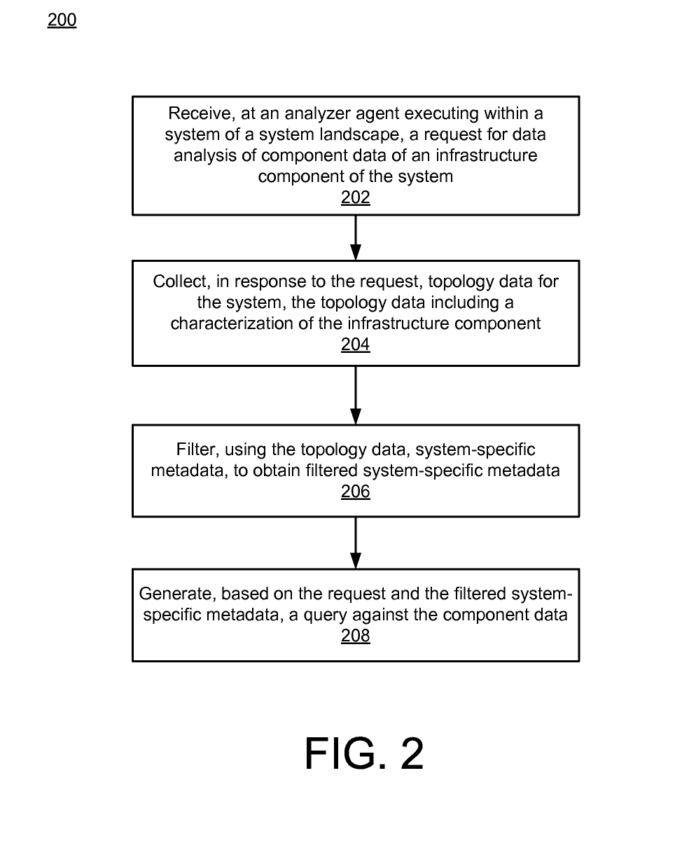

These and other features and functions of the analyzer agent 102, and of the analyzer agents 106, 110, are described in detail below with respect to the specific examples of FIGS. 2-7, and with reference back to the system landscape 100 of FIG. 1. Nonetheless, from the above description of the system landscape 100 of FIG. 1, it may be appreciated that the analyzer agents 102, 106, 110 may be deployed within the system landscape 100 to enable fast, accurate, cost-effective, and timely results for requests such as the request 116. In so doing, a coherent user experience is provided, regardless of where or how the request 116 is received. Further, the various analyzer agents 102, 108, 110 are not only adaptable for implementation at various local systems or other context at a given point in time, but may also be easily updated over time, as system modifications occur within individual local systems. Thus, due to these and other features of the system landscape 100, a user may be provided with a desired type and level of access to system data, and analysis thereof, so that such a user will be fully supported in understanding system operations, minimizing downtime and other system malfunctions, making and implementing decisions for future actions, and otherwise optimizing business objectives or other goals of the user.

FIG. 2 is a flowchart 200 illustrating example operations of the analyzer agent 102 of FIG. 1. In the example of FIG. 2, operations 202-208 are illustrated as separate, sequential operations. In various implementations, however, additional or alternative operations or sub-operations may be included, and/or one or more of the operations 202-208 may be omitted. In such implementations, any two or more of the various operations or sub-operations may be executed in a partially or completely overlapping or parallel manner, or in a nested, iterative, looped, or branched fashion.

In the example of FIG. 2, a request may be received at an analyzer agent executing within a system of a system landscape, the request being for data analysis of component data of an infrastructure component of the system (202). For example, the UI manager 130 may receive the request 116, either by way of a UI provided by the UI manager 130 to a user submitting the request 116 directly at the local system 104. In other examples, other technical components of the analyzer agent 102, e.g., the request controller 132, may directly receive the request 116, including from an automated source, by way of the analyzer agent 110 of the centralized system manager 112, by way of the mobile device 114, or through any appropriate interface configured to receive the request 116. As also described, the request 116 may be related to data analysis of component data for one or more of the infrastructure components 118-126 of the local system 104. As described, such component data may refer to, or include, e.g., data that has already been stored within a particular infrastructure component (e.g., application data of the application 126, or data stored within the database platform 124), metadata characterizing a manner in which such data is stored, or operational data characterizing an operational status of one or more infrastructure components.

In response to the request, topology data for the system may be collected, the topology data including a characterization of the infrastructure component (204). For example, the request controller 132 of the analyzer agent 102 may collect topology data characterizing characteristics of the infrastructure components 118-126. For example, such topology data may include a characterization of a type of hardware being used, an identification of a particular operating system product and operating system product version. Similarly, the topology data may include an identification of a database product of the database platform 124, and associated database product version. Also, the topology data may include similar characterizations of the application 126. Further, the topology data may include characterizations of various interdependencies between various ones of the infrastructure components 118-126. Further examples of such topology data are provided below, or would be apparent to one of skill in the art.

Using the topology data, system-specific metadata may be filtered, to obtain filtered system-specific metadata (206). For example, the content filter 138 of the content manager 136 may receive the topology data from the request controller 132. Then, the topology data may be utilized to parameterize the content filter 138, to thereby abstract a relevant subset of the system-specific metadata 140. As described herein, the system-specific metadata 140 stored in conjunction with the analyzer agent 102 at the local system 104 should be understood to include metadata characterizing all anticipated infrastructure components of the local system 104, and characteristics thereof

For example, with respect to the database platform 124, it may be the case that three different versions of the database platform 124 may potentially be deployed within the local system 104. Consequently, metadata for all three versions may be included in the system-specific metadata 140. Then, at a given point in time that the request 116 is received, the topology data collected by the request controller 132 may reveal that all three versions of the database platform 124 are in operation in various instances within the local system 104, or, in other implementations, may reveal that only a particular one of the database platform versions is in operation. Consequently, based on such topology data, the content filter 138 may retrieve only the portions of the system-specific metadata 140 that will relate to the one or more versions of the database platform 124 that are currently in operation at time of receipt of the request 116.

Based on the request and the filtered system-specific metadata, a query against the component data may be generated (208). For example, continuing the example above, the request 116 may be related to component data associated with the database platform 124. Since such component data may or may not be stored ahead of a receipt of a request 116, or may be stored in a relatively unstructured manner, the request processor 134 may precede to generate a query for, or otherwise interface with, the database platform 124, to thereby obtain or identify the desired component data.

In other words, the request controller 132 may utilize the topology data and the system-specific metadata 140 to map elements of the request 116 to a query of the request processor 134 that is to be applied against the database platform 124, so that the resulting query will be harmonized with respect to an interface of the database platform 124. Then, in the reverse direction, although not explicitly illustrated in the high-level example of FIG. 2, resulting query results may be provided to the request controller 132, and thereby mapped back to a common data model that is partially or completely shared by the various analyzer agents 106, 110, and that is compatible with the various user interface aspects of the UI manager 130. As a result, results for the request 116 may be provided by the analyzer agent 102 in a uniform manner that is consistent with similar request results that might be provided by one or both of the analyzer agent 106 and the analyzer agent 110, for the same or similar request 116.

FIGS. 3-7 illustrate more specific example implementations of the analyzer agent 102 of FIG. 1. In the various implementations described with respect to FIGS. 3-7, and by way of non-limiting, illustrative example, it is assumed that various local systems, such as the local systems 104, 108, are used within a system landscape to execute various vendor-specific types of business software, as well as potentially implementing customized or proprietary business software. It is further assumed that a centralized system manager, similar to the centralized system manager 112 of FIG. 1, but not explicitly illustrated within the examples of FIGS. 3-7, is available for, or compatible with, the various analyzer agent deployed within the hypothetically system landscape. Still further, it is assumed that the local system in question is implementing, as part of a database platform such as the database platform 124, and in-memory database, such as the HANA database system of SAP SE. Such in-memory database systems may be used to process large quantities of data very quickly, even when the data is relatively unstructured. Consequently, analytic capabilities available in conjunction with such an in-memory database platform may be particularly suited for locally processing analytic requests, such as the request 116.

In such hypothetical example scenarios, and as referenced above, the various vendor-specific applications may be configured to run on various combinations of database platforms, operating systems, virtualization layers, and hardware within a particular system. Such infrastructure components, and other infrastructure components not explicitly listed (e.g., cloud services IaaS) components, may be instrumented by corresponding vendors to allow monitoring by customers to keep business processes up and running, as described above with respect to the centralized system manager 112. In the various example implementations of FIGS. 1-7, and notwithstanding the fact that vendor-specific monitoring tools typically focus on their own, vendor-specific infrastructure components, the analyzer agent 102 of FIG. 1 may be configured to provide an integrated view on all such infrastructure components, while still providing localized analysis of analytic requests, even in complex environments.

Of course, it will be appreciated from the present description that operation of the analyzer agent 102 need not rely on a presence, availability, or operation of the centralized system manager 112. On the contrary, as described, the analyzer agent 102 may partially or completely obviate the need for such a centralized system manager 112, since the implementations described herein do not require data replication from across the system landscape to such a centralized data management solution. As a result, for example, the analyzer agents 102, 108 may be distributed for execution within any appropriate system of the system landscape 100, while providing localized analytic processing of specified data.

Turning to FIG. 3, then, an analyzer agent 300, representing, e.g., the analyzer agent 102 of FIG. 1, is illustrated as including agent code 302 and content 304. In other words, the agent code 302 should be understood to represent executable code that operates in a runtime environment of a particular system, to thereby provide various runtime operations associated with satisfying the query 116. Meanwhile, the content 304 corresponds generally to the system-specific metadata 140 of FIG. 1, and generally describes content objects and their dependencies on one another, if any.

Although the analyzer agent 300, as just referenced, may operate completely independently of a centralized data analytic solution, it also may occur, as described with respect to FIG. 1, that such a centralized system manager is already present within a given system landscape, and may itself serve as a home for a particular analyzer agent, such as the analyzer agent 110 of FIG. 1. In this way, users who desire to do so may continue to interact in a known manner with the available centralized system manager 112. In addition to such compatibility concerns, it may occur that various techniques implemented in conjunction with the centralized system manager 112 may be leveraged, perhaps in modified form, for use by the analyzer agent 300 in performing various functions described herein. For example, it may occur that the database 128 of the centralized system manager 112 may be utilized to store collected, replicated data in a uniform fashion, so that the various analyzer agents 102, 108, 110, or the analyzer agent 300 of FIG. 3, may adapt such functionalities of the centralized system manager 112 for use within a corresponding local system in which such analyzer agents are deployed. For example, when creating the database 128, the centralized system manager 112 may store collected, replicated data from the system landscape 100 using predetermined data models or data structures. For example, such data may be consolidated into data providers known as Infocubes that are optimized for reporting functionalities. Then, data from such unified data providers may be processed in order to localize and analyze potential difficulties, or otherwise to utilize the data in question.

In order to leverage or otherwise utilize such an approach, or similar approaches, the various analyzer agents 102, 108, 110 of FIG. 1 may be implemented in accordance with such common data providers (e.g., including common data models) while enabling a mapping of such common data providers for interfacing with individual ones of various local infrastructure components, such as the infrastructure components 118-126 of the local system 104 of FIG. 1.

In other words, the various analyzer agents 102, 108, 110 may communicate with one another using a neutral interface for all infrastructure components being monitored, using a single language and format. Nonetheless, as described, in order to access system-specific component data, a particular analyzer agent, such as the analyzer agent 102, may be configured to map this common language to topology-specific queries for accessing actual, current component data of available infrastructure components. In this way, for example, the request 116 may be translated for generation of specific standard query language (SQL) queries for collecting component data, while enabling storage of thus-obtained component data using data providers that enable the various standard online analytical processing (OLAP) features.

Further in FIG. 3, the agent code 302 is illustrated as including a UI manager 306, corresponding generally to the UI manager 130 of FIG. 1. Similarly, a request controller 308 of the agent code 302 corresponds generally to the request controller 132 of FIG. 1.

In the example of FIG. 3, the UI manager 306 and the request controller 308 have access to topology data 310, illustrated in FIG. 3 as including various types of topology/system/connections data. In various implementations, the topology data 310 may include various types of topology data. For example, the topology data 310 may include relatively high-level topology data that characterizes a system topology with respect to aspects thereof that are generally static or infrequently changing. These types of topology data may be stored ahead of time, or may be collected during initial topology data collection efforts to the request controller 308.

Then, in some implementations, a user of the analyzer agent 300 may interact with a UI provided by the UI manager 306, to thereby provide an initial selection of infrastructure components from available topology data. In other words, when such a user desires to issue a request, such as the request 116, the UI manager 306 may provide the user with an initial opportunity to narrow or otherwise select from among available infrastructure components, to thereby limit subsequent computational requirements with respect to the request controller 308. For example, such high-level topology data may represent infrastructure components in some grouped or categorized fashion (e.g., grouped geographically, or by type, or by relation to a particular software application). Then, the user of the analyzer agent 300 may select, using, e.g., a drop-down menu or other appropriate GUI selection tool, a desired subset of infrastructure components within the topology data that are thought to be relevant for a request being issued.

Aside from these types of UI-enabled topology selections, the request controller 308 may populate the topology data 310 with all available or necessary characterizations of a topology of a managed system 312. Such topology collection efforts of the request controller 308 are described in more detail below, but may generally be understood for purposes of explanation of operations of FIG. 3 to include any and all such topology data that may be relevant to identifying and characterizing infrastructure components of the managed system 312 that may be relevant to a request received by way of the UI manager 306.

Consequently, such topology data may be provided as filter parameters for filtering operations of a content manager 314 with respect to the content 304. As generally described above with respect to the system-specific metadata 140, the content 304 should be understood generally to include content objects which define all potential and valid options for various interfaces (e.g., application program interfaces, or APIs), versions, types, or other characteristics of infrastructure components (or component data thereof) to be analyzed. In addition, as shown in FIG. 3 and described in detail below, the content 304 may include various other content objects related to operations of the agent code 302, such as content objects enabling relevant functionalities of the UI manager 306, and content objects enabling data collection, data modeling, and data analysis efforts of the request controller 308. In particular, in the example of FIG. 3, the content 304 is illustrated as including UI-related content object 316, as well as content object 318 related to a collection and analysis of component data.

In operation, the UI-related content object 316 generally enables a highly customized and efficient implementation of user interfaces by the UI manager 306. For example, if a first request from a first user relates to an operating system component of the managed system 312, then the UI-related content object may be configured to enable a specific, customized user interaction with respect to chaining analytic results for the infrastructure component in question. For example, a navigation content object 320 may enable the UI manager 306 to provide a user interface with custom navigation options related to the type of component data being analyzed. Similarly, a UI content object 324 may enable other aspects of the user interface provided by the UI manager 306, while a personalization content object 322 enables personalized aspects of such a user interface, e.g., or either a specific user issuing the request in question, or for a specific type, class, or group of users. Thus, if a second user issues a second analytic request related to a second infrastructure component of the managed system 312, the various UI-related content object 316 may provide the second user with a customized UI experience that is particularly relevant and efficient for analyzing component data of the infrastructure component in question.

Somewhat similarly, the various content objects 318 related to actual identification, collection, and analysis of desired component data may be implemented in a fast, efficient, cost-effective, and adaptable manner. For example, a data provider content object 326 may generally represent a type of data provider (and associated data model (e.g., Infocube structures) used to structure and analyze collected component data). Meanwhile, a data source content object 328 relates to data collected from specified infrastructure components, so that a mapping content object 330 may be utilized to map a relevant data provider to a corresponding, system-specific infrastructure component. Meanwhile, a request content object 332 may specify types or characteristics of analytic requests that may be processed by the agent code 302. An aggregation content object 334 relates to component data aggregation in the context of analytical processing thereof. Finally with respect to the various content objects of the content 304, a collector content object 336 may be associated with collection efforts related to obtaining and analyzing component data related to a specific request that has been received.

Thus, the various content objects of the content 304 should be understood to include all, or virtually all, content objects that may be related to infrastructure components of the managed system 312. It should be apparent from the above description that not all such content objects will be required for a current, actual topology of the managed system 312, or for a specific request that has been received by the agent code 302. For example, with respect to the UI-related content object 316, various navigation and personalization options may be available for various system topologies and users, thus, only a filtered subset of such possibilities should be provided to the UI manager 306 for generating and implementing corresponding user interfaces.

Similarly, the various content object 318 will include content (e.g., metadata) characterizing the various types of requests, infrastructure components, and available analytic capabilities that may be required for satisfying an analytic result against the managed system 312. Again, as a result, only a filtered subset of the various content objects 318 will be relevant for a particular received query and associated infrastructure component and component data.

By using the topology data 310 as filter parameters for the content manager 314 in filtering the content 304, the request controller 308 may receive a filtered, system-specific set of the metadata stored within the content 304. As a result, the request controller 308 is provided with the information needed to generate and communicate with individual instances of request processors 338, 340. For example, the request processor 338 may be generated for the purpose of applying queries against an operating system infrastructure component of the relevant local system, while the request processor 340 may be configured to issue queries against the database platform 124 of FIG. 1. That is, for example, each request processor 338, 340 may be provided with an ability to issue queries against component data of the various infrastructure components of the managed system 312. Thereafter, the request processor 338 may return obtained component data, so that the request controller 308 may proceed to utilize, e.g., an appropriate data provider of the data provider content object 326, or other ones of the various content objects 318. Further operations of the request controller 308 are described below, e.g., with respect to FIG. 4.

Thus, as a result of operations of the analyzer agent of FIG. 3, the UI manager 306 may receive analytic requests, the request controller 308 (and potentially the UI manager 306) may utilize collected topology data 310 for the managed system 312 to cause the content manger 314 to filter the various content objects of the content 304. Using the thus-obtained filtered system-specific content (e.g., metadata), the request controller 308 may provide corresponding request processors 338, 340, which may then interface with appropriate infrastructure components of the managed system 312 using appropriate interfaces thereof, while providing resulting, collected component data to the request controller 308 in a manner that allows the request controller 308 to structure and store the obtained component data in a manner that facilitates satisfaction of the received analytic query. In this way, the UI manager 306 may provide a user interface that provides the desired request results in a uniform, specific, fast, and cost-effective manner.

Thus, FIG. 3 illustrates an architecture of the described content-driven monitoring solution, in which the agent code 302 provides a content management and interpretation engine, while the content 304 includes and describes content objects for the monitoring solution (and dependencies between such content objects). As a result, as described, the analyzer agent 300 is able to automatically detect the topology data 310 of the managed system 312, so that the topology data may be used in conjunction with the content 304 and the received request to utilize data models of underlying infrastructure components and build up a monitoring solution (e.g., unified data providers, which can be accessed, e.g., through web service calls) during a runtime of the analyzer agent 300. Thus, a decentralized data store is provided for a system landscape, in which all OLAP capabilities (e.g., data consolidation, externalization, and processing) are available at local, decentralized system locations, without requiring data replication to a central system manager.

FIG. 4 is a block diagram illustrating more detailed example implementations of the request controller 308. As shown, a topology collector 402 of the request controller 308 may be included, and may be configured to collect topology data 404 that generally corresponds to the topology data 310 of FIG. 3. For example, the topology collector 402 may be configured to enable an opening of a connection with an infrastructure component (e.g., opening of a database connection), which may then be utilized to determine various versions and features of the infrastructure component in question, along with identification of which such versions and features are enabled. These and other examples of topology data may be stored within the topology data 404 of FIG. 4.

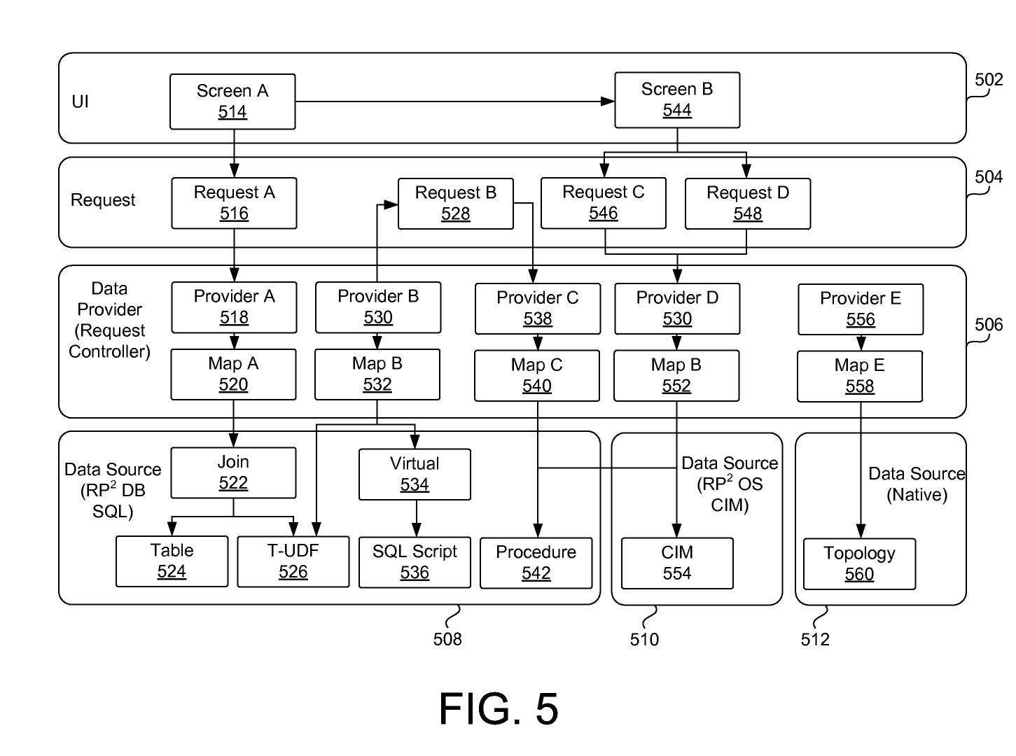

Through using the topology data 404 as filtered parameters for the content manager 314, the request controller 318 may obtain filtered system-specific metadata 406, which corresponds generally to filtered content objects of the content 304 of FIG. 3. The filtered system-specific metadata 406 thus provides specific, required APIs, versions, or topologies for one or more infrastructure components in question, along with associated mapping that may be required for such infrastructure components, and all necessary data providers that will be mapped in accordance therewith. Then, a mapping manager 408 may be configured to utilize the determined mapping and thereby coordinate communications between the request controller 308 and the various ones of the request processors 338, 340. Further examples of such mapping operations, and other aspects of the analyzer agent 300 including the request controller 308, are provided below, e.g., with respect to FIGS. 5-7.

In operation, the request controller 308 may include various other components. For example, a correlation manager 410 is illustrated that may be configured to perform specific functions with respect to coordinating operations of the various request processors 338, 340. For example, the correlation manager 410 may be configured to track which such request processors are associated with a specific request, topology, and/or subset of filtered system-specific metadata. In this way, component data may be collected in a fast, efficient manner, and may ultimately be correlated for inclusion thereof within a data provider to be used in providing request results for the request in question.

Finally in the example of FIG. 4, a chaining manager 412 may be configured for managing interactions between various analyzer agents, e.g., the analyzer agent 102, 108, and 110. For example, as described, the various analyzer agents 102, 108, and 110 may be in communication with one another, using a common, platform independent format/language. Through the use of associated communications, the chaining manager 412 may coordinate interactions of the various analyzer agents in a manner that leverages their cumulative capabilities. For example, the chaining manager 412 may assist in forwarding a particular request to an analyzer agent that is closest to the component data being requested within the given system landscape. In other example implementations, e.g., for the analyzer agent 110 executing within the centralized system manager 112, the chaining manager 412 may enable the analyzer agent 110 to act as a proxy for the analyzer agent 102 during analysis of the various infrastructure components 118-126 of the local system 104. For example, such a proxy role of the analyzer agent 110 may be implemented for the benefit of a user who wishes to submit their request 116 at the centralized system manager 112, without requiring a type of large scale data replication thereto that is discussed herein. For example, analytic requests against a central database may be translated into web service calls targeting local systems.

FIG. 5 illustrates software layers corresponding to an implementation of the analyzer agent 300 of FIG. 3. In the example of FIG. 5, a UI layer 502 corresponds generally to the UI manager 306 of FIG. 3. A request layer 504 corresponds to a request, or plurality of requests, received by the analyzer agent 300. A layer 506 corresponds to a plurality of data providers associated with the request controller 308. Meanwhile, elements 508, 510, 512 of a data source layer each correspond respectively to data sources used to obtain desired component data and/or topology data. That is, as explained in detail below, each such data source may be understood to correspond to an instance of a request processor, such as the request processors 338, 340. In the example of the element 512, the data source may be native to the management system 312 in question, and may be used to obtain topology data 560 corresponding generally to the topology data 310 of FIG. 3, as described in more detail below.

Then, during runtime, at a screen 514 of the UI layer 502, a request 516 may be received. Through the various operations of the request controller 308 described above with respect to FIGS. 3 and 4, a data provider 518 may be selected, and associated mapping 520 may enable interactions between the provider 518 and a query executed in conjunction with the data source (request processor) in question. For example, as shown, such a query may include a join element 522, specified in conjunction with a table 524 and a user defined function (UDF) element 526.

Meanwhile, a request 528 may be received outside the context of the UI layer 502, as referenced above. In such scenarios, the above-described operations of the agent analyzer 300 are still relevant for purposes of selecting corresponding providers 530, 538, along with respective mappings 532, 540. Through the use of such mappings, desired queries can be executed using corresponding interface types. Specifically, as shown, the user defined function 526 may be utilized, along with using a virtual component 534 to generate a desired SQL script 536. Meanwhile, as shown, the provider 538 is mapped via mapping 540 to a stored procedure 542 illustrating an example of common interface types that may be used to access the desired component data.

Further in FIG. 5, a screen 544 may be utilized to receive a request 546 and a request 548. As shown, both requests 546, 548 are mapped associated with a particular data provider 530, which is itself mapped using a mapping 552 to a common information model (CIM) 554. Finally in FIG. 5, the request controller of the layer 506 may select and utilize an appropriate provider 556 and associated mapping 558, for purposes of collecting topology data of the topology node 560 from the various native infrastructure components of the managed system 312 in question.

Thus, the data source layer (i.e., the lowest layer of FIG. 5) provides an entry point for monitoring data within the system being monitored. The data source layer describes interfaces to various infrastructure components being monitored, where, as may be appreciated from the above description of FIG. 5, such common interface types may include tables, stored procedures, or functions for databases. In practice, as described above with respect to the request processors 338, 340 of FIG. 3, it may be necessary or helpful to utilize one request processor, or type of request processor, for use with a corresponding infrastructure component or type of infrastructure component. In other words, for example, the data source 508 may correspond to the query to be issued against the database platform 124. Meanwhile, the data source 510 may utilize the illustrated CIM provider 554, or other appropriate interface type, to interact with the OS infrastructure component 122. Of course, other data sources may be included for interacting with various other ones of the infrastructure components 118-126 of FIG. 1.

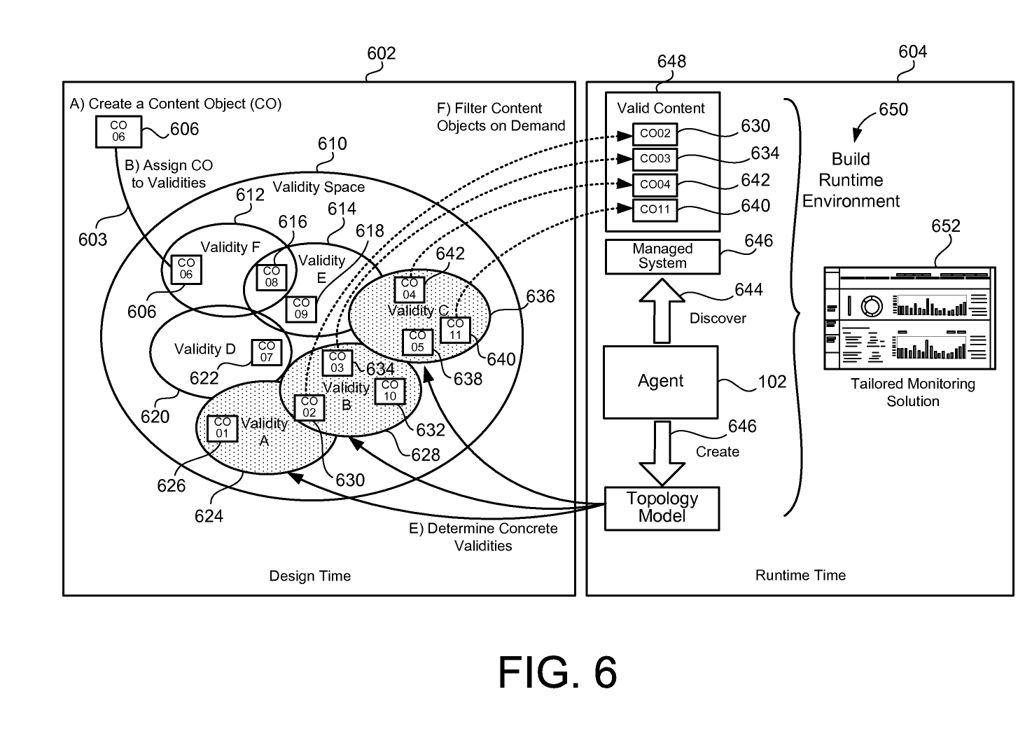

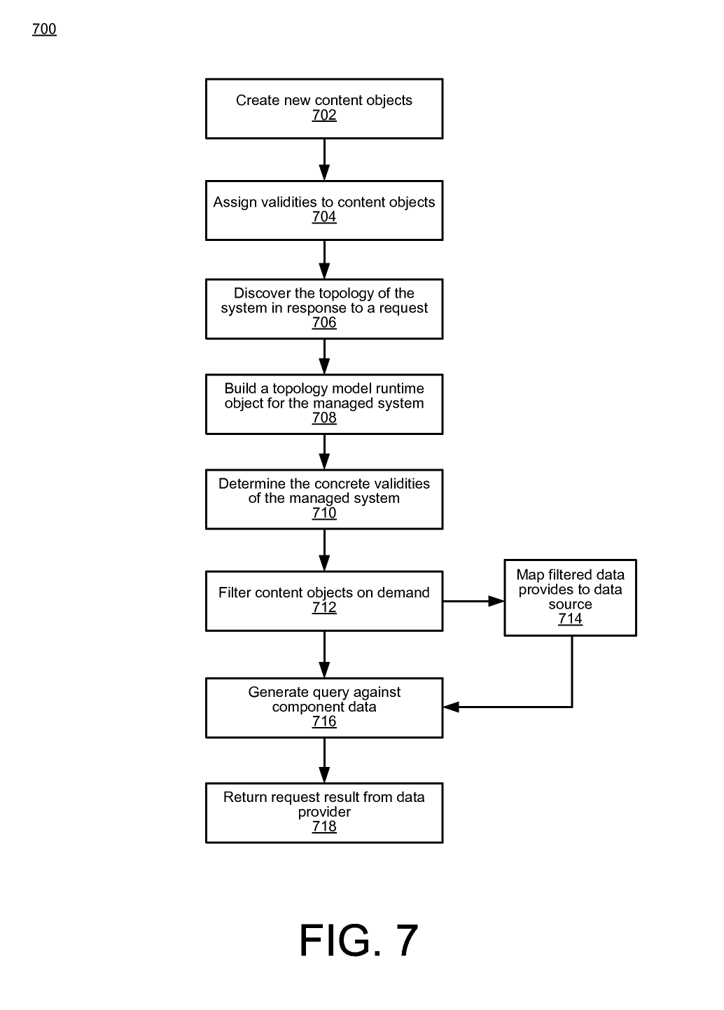

FIG. 6 illustrates a design time 602 and a runtime 604 that may occur during the creation and implementation of the systems of FIGS. 3-5, above. FIG. 7 is a flowchart 700 illustrating example operations associated with the example of FIGS. 1-6.

Although not specifically illustrated in the examples of FIGS. 6 and 7, it will be appreciated that in these examples, and in earlier examples, that the analyzer agent 102 is capable of monitoring various aspects of applications that can be correlated with monitoring data from other infrastructure components, e.g., of the same system.

As shown in FIG. 6, a content object 606 may be created and assigned (608) to a validity space 610, as illustrated in FIG. 7 (702, 704). As may be appreciated, the validity space 610 generally represents all valid components, versions, configurations, data providers, and other aspects of the system-specific metadata 140 (e.g., the content 304 of FIG. 3). Thus, the content object 606, and all of the various content objects of FIG. 6, should be understood to represent content to be filtered by the content manager(s) 136, 314 of FIGS. 1 and 3.

Thus, as shown, various other content objects may be assigned to associated validity spaces. Specifically, as illustrated, a validity space 614 (for a certain, corresponding type of content object) may overlap with validity space 612 to include the content object 616, while the content object 618 is included exclusively within the validity space 614. A validity space 620 may include a content object 622, while a validity space 624 includes a content object 626. A validity space 628 includes, and a portion overlapping with the validity space 624, a content object 630, along with content objects 634 and 632 residing exclusively within a validity space 628. A validity space 636 is also illustrated as including content objects 638, 640, and 642.

Once the various content objects have been assigned within the validity space 610, the design time 602 is effectively completed, and, upon receipt of a request, the runtime 604 commences. Specifically, the agent 102 (also representative of the analyzer agent 300 of FIG. 3) may proceed to discover a topology of an underlying system, as represented by arrow 644 and managed system 645 of FIG. 6 (706). Subsequently, as indicated by arrow 646, a topology model runtime object 647 for the managed system 645 may be built (708).

Subsequently, concrete validities of the managed system 645 may be determined using the topology model 647, as represented by arrows 648 (710). Further, valid content 649 may be obtained through on-demand filtering of the design time content object, as represented by arrows 650 in FIG. 6 (712).

Subsequently, resulting filtered data providers may be mapped to corresponding data sources (714), to thereby build a runtime environment (illustrated with arrow 651 in FIG. 6, and thereby obtain a tailored monitoring solution 652). With such a tailored monitoring solution 652, a query may be generated against component data (716), so that a request result may be returned from a corresponding data provider (718).

By way of specific example, a local system may be running on an in-memory database in a cloud platform. In response to a received analytic request, the local agent may then detect the current topology and build up a runtime with the help of (filtered) data models that externalize data providers for the business software application, the in-memory database, the operating system, and other monitored/collected component data. These data providers may allow access via oData calls, which are locally processed and transformed into queries against the underlying stack components using SQL, Web Services or other query languages.

In the various implementations described herein, the analyzer agent(s) are configured to deal with all possible combinations of stack components, to handle concrete system environments at runtime. As described, the analyzer agents filters out those elements of the data model (e.g., system-specific metadata 140 or content 304) that are relevant for the given system environment, where filters are set according to the discovered system topology. In this way, changes to stack components may be detected and handled accordingly at runtime.

Further, as new products and product versions of stack components get supported over time, the analyzer agent is easily updated to support these new environments. That is, instead of requiring code changes (e.g., changes to the code 302 of FIG. 3), which would likely require downtime of the underlying system, the data model may be shipped as content (e.g., .zip, .xml) independently from agent code. The agent can be content-updated without downtime at any time.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Non-transitory information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed, are configured to:
receive, at an analyzer agent executing within a system of a system landscape, a request for data analysis of component data of an infrastructure component of the system;
collect, in response to the request, topology data for the system, the topology data including a characterization of the infrastructure component;
filter, using the topology data, system-specific metadata, to obtain filtered system-specific metadata; and
generate, based on the request and the filtered system-specific metadata, a query against the component data.

2. The computer program product of claim 1, wherein the instructions, when executed, are further configured to cause the at least one processor to:
receive the request by way of a user interface of the analyzer agent.

3. The computer program product of claim 1, wherein the instructions, when executed, are further configured to cause the at least one processor to:
receive the request by way of a user interface, including generating the user interface based on the topology data and the filtered system-specific data.

4. The computer program product of claim 1, wherein the instructions, when executed, are further configured to cause the at least one processor to:
receive the request from a second analyzer agent within the system landscape.

5. The computer program product of claim 1, wherein the topology data includes product and version information for the infrastructure component.

6. The computer program product of claim 5, wherein the system-specific metadata includes potential products and versions of the infrastructure component, and the filtered system-specific metadata includes a subset of the products and versions relevant to the infrastructure component.

7. The computer program product of claim 1, wherein the system-specific metadata includes data models modeling system data of the system, and the filtered system-specific metadata includes a subset of the data models relevant to the infrastructure component.

8. The computer program product of claim 7, wherein the instructions, when executed, are further configured to cause the at least one processor to:
map the subset of the data models to a corresponding interface of the infrastructure component.

9. The computer program product of claim 7, wherein the instructions, when executed, are further configured to cause the at least one processor to:
return request results, based on the subset of data models, such that the request results are provided using a user interface consistent with a user interface of a second analyzer agent within the system landscape.

10. The computer program product of claim 1, wherein the instructions, when executed, are further configured to cause the at least one processor to:
execute the query during a runtime of the system

11. The computer program product of claim 1, wherein the instructions, when executed, are further configured to cause the at least one processor to:
execute communications between the analyzer agent and at least a second analyzer agent within the system landscape, using a language and format that is common to the analyzer agent and the at least a second analyzer agent, but independent of the infrastructure component.

12. The computer program product of claim 1, wherein the instructions, when executed, are further configured to cause the at least one processor to:
update the system-specific metadata independently of execution code of the analyzer agent, and without requiring downtime of the execution code.

13. A computer-implemented method for executing instructions stored on a non-transitory computer readable storage medium, the method comprising:
receiving, at an analyzer agent executing within a system of a system landscape, a request for data analysis of component data of an infrastructure component of the system;
collecting, in response to the request, topology data for the system, the topology data including a characterization of the infrastructure component;
filtering, using the topology data, system-specific metadata, to obtain filtered system-specific metadata, wherein the system-specific metadata includes data models modeling system data of the system, and the filtered system-specific metadata includes a subset of the data models relevant to the infrastructure component;
mapping the subset of the data models to a corresponding interface of the infrastructure component; and
generating, based on the request and the mapping, a query against the component data.

14. The computer-implemented method of claim 13, further comprising:
returning request results, based on the subset of data models, such that the request results are provided using a user interface consistent with a user interface of a second analyzer agent within the system landscape

15. The computer-implemented method of claim 13, further comprising:
executing communications between the analyzer agent and at least a second analyzer agent within the system landscape, using a language and format that is common to the analyzer agent and the at least a second analyzer agent, but independent of the infrastructure component.

16. The computer-implemented method of claim 13, further comprising:
updating the system-specific metadata independently of execution code of the analyzer agent, and without requiring downtime of the execution code.

17. A system including instructions recorded on a non-transitory computer-readable storage medium, and executable by at least one processor, the system comprising:
a user interface (UI) manager configured to cause the at least one processor to receive, at an analyzer agent executing within a system of a system landscape, a request for data analysis of component data of an infrastructure component of the system;
a request controller configured to cause the at least one processor to collect, in response to the request, topology data for the system, the topology data including a characterization of the infrastructure component;
a content manager configured to cause the at least one processor to filter, using the topology data, system-specific metadata, to obtain filtered system-specific metadata; and
a request processor configured to cause the at least one processor to generate, based on the request and the filtered system-specific metadata, a query against the component data.

18. The system of claim 17, wherein the infrastructure component is included in a component stack of the system, and wherein the request controller is configured to cause the at least one processor to generate the request processor specific to a type of the infrastructure component within the component stack.

19. The system of claim 18, wherein the request controller is configured to cause the at least one processor to:
generate a second request processor specific to a second type of infrastructure component within the component stack for generation of a second query against second component data of a second infrastructure component; and
coordinate query results of the query and second query results of the second query for providing of aggregated query results to the UI manager.

20. The system of claim 17, wherein the system-specific metadata is updatable independently of execution code of the analyzer agent, and without requiring downtime of the execution code.
